(19) United States
(12) Patent Application Publication
(10) Pub. No.: US 2023/0289214 A1
(43) Pub. Date: Sep. 14, 2023

(54) INTELLIGENT TASK MESSAGING QUEUE MANAGEMENT

(71) Applicant: International Business Machines Corporation, Armonk, NY (US)

(72) Inventors: Gang Tang, Nanjing (CN); Peng Hui Jiang, Beijing (CN); Guang Han Sui, Beijing (CN); Liang Rong, Suzhou (CN); Jun Su, Beijing (CN)

(21) Appl. No.: 17/688,958

(22) Filed: Mar. 8, 2022

(51) Int. Cl. G06F 9/48; G06F 9/50; G06F 9/54

(52) U.S. Cl. CPC G06F 9/4881; G06F 9/5038; G06F 9/546

(57) ABSTRACT

An approach for intelligent task message queue management may be provided herein. The approach may include receiving a task message from a producer at an intelligent task message queue management service. The approach may include assigning a subclass to the task message based on a predetermined set of rules. The approach may include assigning the task message to a one of a plurality of subclass worklist queues based on the assigned subclass. The approach may include generating a subclass score for the task message based on a weight associated with the assigned subclass work queue. The approach may include dispatching the task message to a consumer based on the generated subclass score for the task message.

### BACKGROUND OF THE INVENTION

The present invention relates generally to the field of workflow management, more specifically, task message queue workflow.

Workflow queues or task queues allow for the scheduling or delay of computing tasks within a system. The task is encapsulated as a message, and it is sent to a message queue. A worker process will pick up the message from the queue and execute the process. The worker process will sometimes pick up a task message based on a predetermined policy or whenever computing resources become available to perform the task. In some message queue systems, more than one worker process may perform the task and balance the resource requirements between them.

### SUMMARY

Embodiments of the present disclosure include a computer-implemented, method a computer system, and a computer program product for intelligent task message queue management. Embodiments of the invention may include, assigning a subclass to a task message based on a predetermined set of rules, wherein a plurality of subclasses exist within an intelligent task message queue management service. Embodiments may also include assigning the task message to a subclass worklist queue based on the assigned subclass, wherein each of the plurality of subclasses has a corresponding subclass worklist queue. Additionally, embodiments may also include generating a subclass score for the task message based on a weight associated with the subclass worklist queue. Embodiments of the present disclosure may include dispatching the task message to a consumer based, at least in part, on the generated subclass score for the task message.

It should be understood, the above summary is not intended to describe each illustrated embodiment of every implementation of the present disclosure.

### BRIEF DESCRIPTION OF THE DRAWINGS

FIG. 1 is a functional block diagram of an intelligent task messaging queue system, generally designated 100, in accordance with an embodiment of the present invention.

FIG. 2 is a functional block diagram of a subclass task messaging queue engine, generally designated 200, in accordance with an embodiment of the present invention.

FIG. 3 is a flowchart of a method for subclass task messaging queue workflow, generally designated 300, in accordance with an embodiment of the present invention.

FIG. 4 is a functional block diagram of an exemplary computing system 10 within a reasoning based workflow management environment, in accordance with an embodiment of the present invention.

FIG. 5 is a diagram depicting a cloud computing environment 50, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted allow for intelligent subclass based task messaging queue management. In an embodiment of the invention, task messages can be classified into subclasses. A task queue is an application or program that can receive requested task messages from a producer. The task messages can be placed into a task queue where they can be dispatched, at a later time, to consumers which will execute the programs. It should be noted throughout this description, the terms work queue and task queue will be used interchangeably and should be afforded the same meaning. Further, it should be understood that a task message is a request from a producer to execute some operation or process and throughout this description the terms task message and message will be used interchangeably and should be afforded the same meaning.

In complex computing systems, flexibility and scalability are a necessity to efficiently and rapidly schedule and process tasks dynamically. Typically, task messages from producers are compiled into a single list by a queue message service. The queue message service will then dispatch the task message to a consumer based on a pre-defined policy. A policy is generally a rigid framework that cannot adapt to the current needs of the complex computing system. This requires constant user input and updates or that the user build out an entire queue messaging service or add a layer to an existing queue messaging service that is customized to the complex computing system.

In an embodiment of the invention, a producer can send a task message to a queue message service. In the task message, the producer names the message and assigns a subclass to the message. The queue message service can receive the task message. The queue message service can keep a running list (e.g., a subclass task list) of all the messages with the same subclass. The queue message service can calculate a current priority score for the subclass (e.g., subclass priority score). The queue message service can dispatch the message to a consumer when the consumer becomes available. The consumer can pick-up the task message and return an acknowledgement to the queue message service. The queue message service can adjust the priority score using the acknowledgement from the consumer.

In an embodiment, the queue messaging service is a component of a multi-tenant computing system (e.g., public cloud, hybrid cloud, private cloud). Workload engines in the computing system can run the requested tasks of the tenants. Although embodiments of the present invention are generally directed to only two tenants, embodiments of the present invention can be practiced using any number of tenants in an intelligent task messaging queue (e.g., 2, 3, n . . . n+1). A subclass can be assigned to each tenant. In another instance, the subclass that accompanies the task message can be based on the type of task that is to be run. For example, a subclass with a high priority subclass might be assigned to a system or business critical type workload, while a lower priority subclass for a data type conversion or data backup task can be assigned to or accompany a task message. In another example, a subclass can represent a time to execute a task (e.g., execute the task as soon as possible, execute the task when computing resources are less utilized, and/or the cost of using computing resources is lower).

In an embodiment, the subclass priority score can be calculated based on a number of factors (e.g., tenant subscription class, tenant local time, time of year). For example, tenant 1 is a premium subscription member, while tenant 2 is a standard subscription member. Queue task message service can have a policy in place where it dispatches a predetermined number of tenant 1's task messages to a consumer before tenant 2's tasks until that number of tenant 1's tasks have been dispatched, at which point it will also dispatch tenant 2's task messages. In the immediate example, a use case might be in a system where all system resources are expected to be utilized at all times. A subclass priority score could be determined in the following manner: tenant 1's tasks equate to 100 times the CPU usage of tenant 2's, in other words:

```
Queue_name = task_queue,
dequeue = function deq( ){
  if (tenant1 score / 100< tenant2) // tenant1 can use 100 times of the
  resources as tenant2
    pick message from tenant 1
      else
    pick message from tenant 2
```

In an embodiment, the consumer can return feedback to the queue message service via a callback message. A callback message can be a message request to the consumer that is executing an acknowledged task from the queue message service. The feedback can provide multiple details about the task (corresponding to the task message) that is being executed (e.g., the computing resources that are utilized, estimated time to complete the task, the databased that must be accessed to accomplish the task).

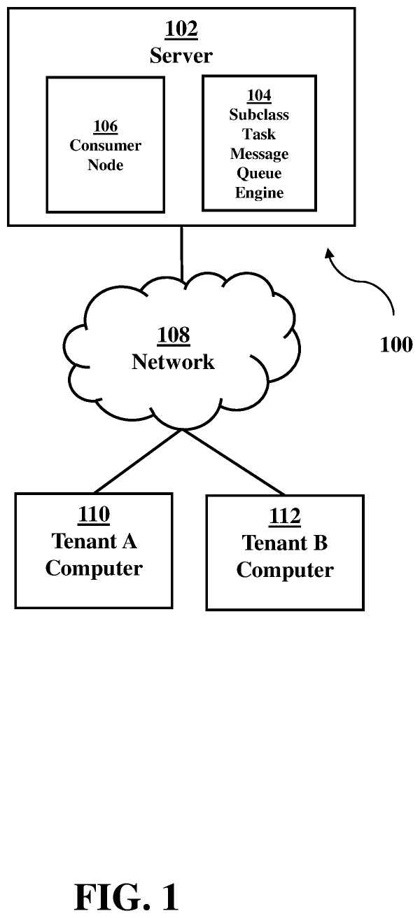

Referring now to the Figures, FIG. 1 is a functional block diagram generally depicting intelligent task messaging queue system 100, in accordance with an embodiment of the invention. Intelligent task messaging queue system 100 comprises subclass task message queue engine 104 and consumer node 106 operational on server 102. Also depicted in intelligent task messaging queue system 100 is tenant A computer 110 and tenant B computer 112 interconnected over network 108. In an alternative embodiment, consumer node 106 can be located on a separate server than server 102, such as in a cloud computing environment.

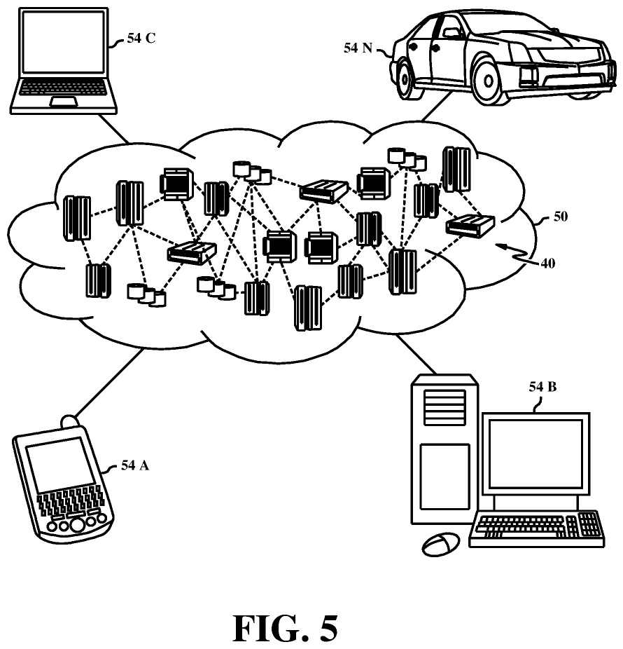

Server 102, tenant A computer 110, and tenant B computer 112 can be a standalone computing device, a management server, a web server, a mobile computing device, or any other electronic device or computing system capable of receiving, sending, and processing data. In other embodiments, server 102 tenant A computer 110, and tenant B computer 112 can represent a server computing system utilizing multiple computers as a server system such as in cloud computing environment 50 (depicted in FIG. 5). In an embodiment, server 102 tenant A computer 110, and tenant B computer 112 can represent a computing system utilizing clustered computers and components (e.g., database server computers, application server computers, etc.) that act as a single pool of seamless resources when accessed within intelligent task messaging queue system 100. In another embodiment, server 102 tenant A computer 110, and tenant B computer 112 can be a laptop computer, a tablet computer, a netbook computer, a personal computer, a desktop computer, or any programmable electronic device or combination of programmable electronic devices capable of executing machine readable program instructions and communicating with each other, and other computing devices (not depicted) within intelligent task messaging queue system 100 via network 108. It should be noted, while only a single device is shown in FIG. 1 for server 102 tenant A computer 110, and tenant B computer 112, in other embodiments, multiple servers or other computing devices can be present within intelligent task messaging queue system 100.

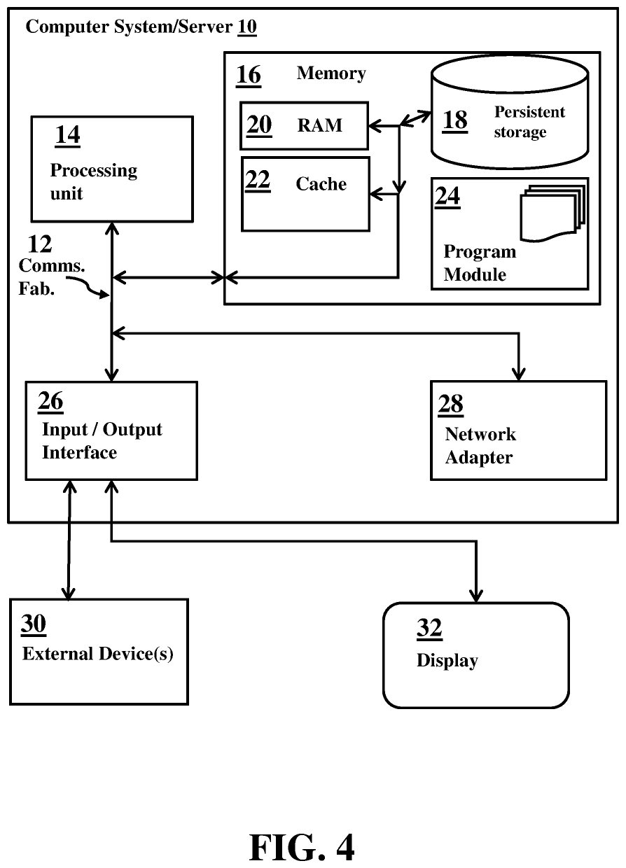

Server 102, tenant A computer 110, and tenant B computer 112 may include components as depicted and described in further detail with respect to computer system 10 in FIG. 4. Server 102 tenant A computer 110, and tenant B computer 112 may include components as depicted and described in further detail with respect to cloud computing node 40 of cloud computing environment 50 in FIG. 5. It should be noted tenant A computer 110 and tenant B computer 112 are producers of task messages. The task messages can be workloads from the users associated with a subscription program for each tenant. In other words, the subscription plan of a tenant will correspond to the tenant's computer.

Network 108 can be a telecommunications network, a local area network (LAN), a wide area network (WAN), such as the Internet, or a combination of the three, and can include wired, wireless, or fiber optic connections. Network 108 may include one or more wired and/or wireless networks that are capable of receiving and transmitting data, voice, and/or video signals, including multimedia signals that include voice, data, and video information. In general, network 108 can be any combination of connections and protocols that will support communications between server 102 tenant A computer 110, and tenant B computer 112 and external computing devices (not shown) within intelligent task messaging queue system 100.

Subclass task message queue engine 104 is a computer program capable of receiving a task message from a tenant and performing enqueue, dequeue, and refresh functions in response to predetermined rules, computing system conditions, and/or number of task messages per subclass. In an embodiment, multiple clones of subclass task message queue engine 104 can be present on multiple servers within intelligent task messaging queue system 100. For example, subclass task message queue engine 104 may be a program such as an intelligent task messaging queue service. The intelligent task messaging queue service can be a computer program configured to operate on a server or cloud based platform (public, hybrid, or private).

The intelligent task messaging queue service may include a multi-tenant configuration, where tenants (i.e., tenant A computer 110 and tenant B computer 112) have different priority levels based on numerous factors. For example, in an embodiment, tenant A computer 110 may have a tier 1 or premium subscription to an image recognition platform on a public cloud. Tenant B computer 112, however, may have a tier 2 or standard subscription. The tier 1 subscription may entitle tenant A computer 110 to a priority level where the computing resources (processing power, memory usage, power consumption, etc.) utilized by tenant A computer 110 can exceed 100 times that of tenant B computer 112 before tenant B computer's 112 workloads will be given priority. That being said, it allows for tenant A computer 110's workloads to be processed but does not foreclose the possibility of tenant B computer's 112 workloads to be processed. In some cases, tenant A computer 110 may not utilize the full amount of computing resources (i.e., the 100× tenant B computer's 112). In this scenario, tenant B computer's 112 workloads can be executed since tenant A computer 110 is not utilizing its full computing power. However, if tenant A computer 110 were to dispatch a task message, tenant B computer's 112 workload would be offloaded allowing for only the utilization of the 1 to 100 computing resource requirement.

Consumer node 106 is a computing node that can be configured to process task messages received by subclass task message queue engine 104. In an embodiment, consumer node 106 can be a container, virtual machine, physical computing machine or the like that can process a task message. It should be noted, while consumer node 106 is shown on server 102, consumer node 106 can be operational on a different computing device(s). Consumer node 106 can also be accessible by network 108. Further, in an embodiment, consumer node 106 can be a program that can receive task messages and send an acknowledgement message indicating it has received a task message and that it will process the workload associated with the task message. The acknowledgement message can have the subclass score of the task message injected into the acknowledgement message for further processing by modules of subclass task message queue engine 104 (described further below).

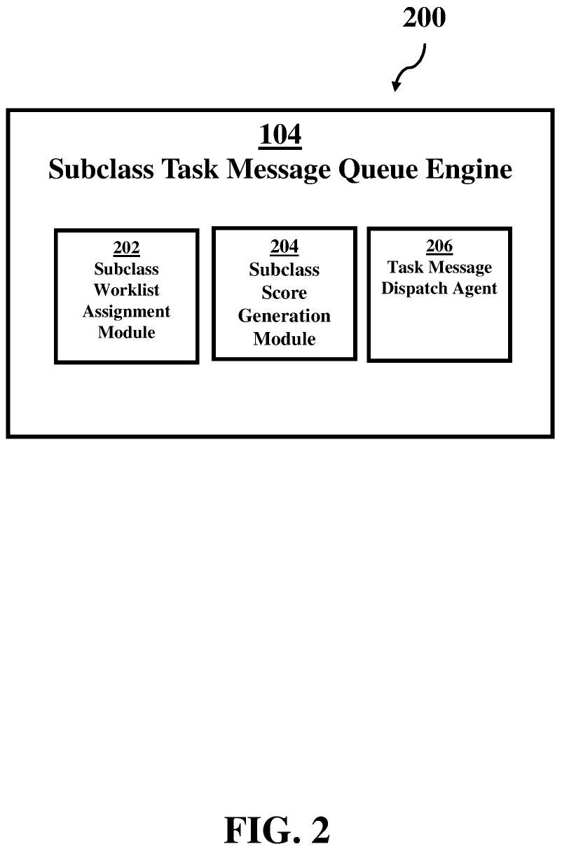

FIG. 2 is block diagram 200 comprised of subclass task message queue engine 104. Subclass task message queue engine 104 can be comprised of subclass worklist assignment module 202, subclass score generation module 204, and task message dispatch agent 206.

Subclass worklist assignment module 202, is a computer module that can receive a task message from a producer and assign the task assignment a subclass. In an embodiment, subclass worklist assignment module 202 can receive a task message from a producer (e.g., tenant A computer 110), in which the task message can have a subclass associated with it already if the producer is a part of a single subclass. In another embodiment, the task message may be a specific type of task message that can only be assigned to a specific subclass (e.g., a producer has paid extra for the task message to have priority since the task message is associated with a closely approaching deadline).

Subclass score generation module 204 is a computer module that can maintain one or more subclass worklist queues and generate a subclass score for each task message within each subclass worklist queue. For example, a subclass score generation module 204 may have two subclass worklist queues in an intelligent task messaging queue service. Each subclass worklist queue can correspond to a specific tenant or be associated with a type of time sensitive workload. Each subclass worklist queue can have a specific weight which is dynamically calculated based on one or more factors (e.g., the number of task messages in the queue, computing resources available, subscription plans, etc.).

In an embodiment, subclass score generation module 204 can periodically refresh the weights of the subclass worklist queue to a predetermined value. It can refresh the weight of a single subclass worklist queue or multiple subclass worklist queues. The refresh rate at which the weights are reset can be temporal in nature (e.g., one hour, every 24 hours, every week) or it can be in response to a certain number of workloads processed from a subclass worklist queue. In another embodiment, the subclass worklist queue weights can be reset in response to a predetermined amount of computing resources that have been utilized to process the queued task messages.

In an embodiment, subclass score generation module 204 can calculate a subclass score for a received task message assigned to a subclass worklist queue. For example, a task message can be received from tenant A computer 110. The task message can be for a business critical workload and tenant A computer 110 has a premium subscription, which places the task message in a primary priority slot to be dispatched to the next consumer. The subclass score can be between one and one hundred, with the weight of the subclass worklist queue it is placed in being 100.

In another embodiment, a task message may be placed in a subclass worklist queue with a weight of 4 while all task messages in the subclass worklist queue receive an initial score of 15. Subclass score generation module 204 can update the subclass score dynamically in response to other task messages in the subclass worklist queue or other subclass worklist queues being dispatched to consumer nodes and an acknowledgement received from a consumer node. For example, the initial score may be stepped up by one with each dispatched task message from the subclass worklist queue, resulting in a higher subclass score the longer the task message is in the subclass worklist queue (e.g., an additional one point for each hour it is in the queue), while other task messages in the worklist queue are dispatched and acknowledged by consumers.

In another example, subclass score generation module 204 can update the weight of the subclass worklist queue in response to receiving acknowledgement of task messages from consumers. For example, a consumer may send an acknowledgement of a task message with the subclass score for a task message injected into the acknowledgement. Subclass score generation module 204 can update the weight of the subclass worklist in response to receiving said acknowledgement. The weight can be increased or decreased based on the resources used to process the task message. The resource usage can be estimated by the consumer node based on the task message and prior similar task messages from the same subclass worklist queue (e.g., language translation, image classification, etc.).

Task message dispatch agent 206 is a computer module that can be configured to dispatch task messages with the highest priority score to consumers with available computing resources. In an embodiment, task message dispatch agent 206 can monitor consumers and computing resource utilization within an intelligent task messaging queue service. For example, task message dispatch agent 206 can be operational within an ephemeral layer. The ephemeral layer can be a layer of abstraction over a containerization or virtual machine system with load balancing and intelligent resource management. It should be noted, task message dispatch agent 206 can be a process which has multiple clones operational on multiple computing systems and operate in unison to efficiently dispatch priority task messages.

In an embodiment, task message dispatch agent 206 can monitor the subclass worklist queues managed by subclass score generation module 204. Upon detecting a consumer has completed a workload or has available computing resources, task message dispatch agent 206 can send the task message with the highest priority to the consumer (such as consumer node 106). In an embodiment, task message dispatch agent 206 can receive an acknowledgement a consumer has received the dispatched task message and will perform the associated workload. The acknowledgment can also contain the subclass score of the associated task message. Task message dispatch agent 206 can send the details of the task message and subclass score to subclass score generation module 204 for subclass worklist queue management by subclass score generation module 204.

It should be noted all the modules shown operational on subclass task message queue engine 104 can operate individually or in concert with each other to perform intelligent task messaging queue management in an efficient and fast manner. That being said, subclass task message queue engine 104 can operate as an intelligent agent with machine learning capabilities to better manage and predict the resource utilization of the task messages. Further, the intelligent agent can perform the capabilities as described above in the same or similar manner, utilizing one or more machine learning models (e.g., deep neural networks) to enforce and enhance any administrative rules for managing subclass queues of task messages or generating priority scores (e.g., subclass score).

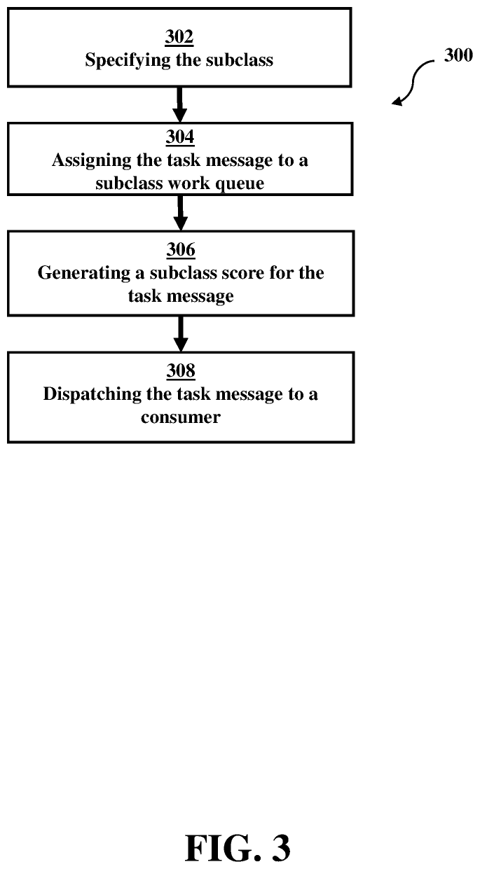

FIG. 3 is a flowchart depicting method 300 for reasoning based workflow management, in accordance with an embodiment of the present invention. At step 302, subclass worklist assignment module 202 can specify a subclass for a task message received by subclass task message queue engine 104 from a producer. At step 304, subclass score generation module 204 can assign the task message with the specified subclass to a corresponding subclass worklist queue. At step 306, subclass score generation module 204 can generate a subclass score for the task message within the subclass worklist queue based on the weight of the subclass worklist queue. At step 308, task message dispatch agent 206 can dispatch the task message to a consumer based on the generated subclass score.

FIG. 4 depicts computer system 10, an example computer system representative of server 102, tenant A computer 110 and tenant B computer 112. Computer system 10 includes communications fabric 12, which provides communications between processing unit 14, memory 16, persistent storage 18, network adaptor 28, and input/output (I/O) interface(s) 26. Communications fabric 12 can be implemented with any architecture designed for passing data and/or control information between processors (such as microprocessors, communications, and network processors, etc.), system memory, peripheral devices, and any other hardware components within a system. For example, communications fabric 12 can be implemented with one or more buses or a crossbar switch.

Memory 16 and persistent storage 18 are computer readable storage media. In an embodiment, memory 16 includes random access memory (RAM) 20. In general, memory 16 can include any suitable volatile or non-volatile computer readable storage media. Cache 22 is a fast memory that enhances the performance of processing unit 14 by holding recently accessed data, and data near recently accessed data, from memory 16.

Program instructions and data used to practice embodiments of the present invention may be stored in persistent storage 18 and in memory 16 for execution by one or more of the respective processing units 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The program/utility, having at least one program module 24, may be stored in memory 16 by way of example, and not limiting, as well as an operating system, one or more application programs, other program modules, and program data. Each of the operating systems, one or more application programs, other program modules, and program data or some combination thereof, may include an implementation of a networking environment. Program module 24 generally carries out the functions and/or methodologies of embodiments of the invention, as described herein.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network Adaptor 28, in these examples, provides for communications with other data processing systems or devices. In these examples, network adaptor 28 includes one or more network interface cards. Network Adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface(s) 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 30 provides a mechanism to display data to a user and may be, for example, a computer monitor, touchscreen, and/or augmented virtual reality device.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

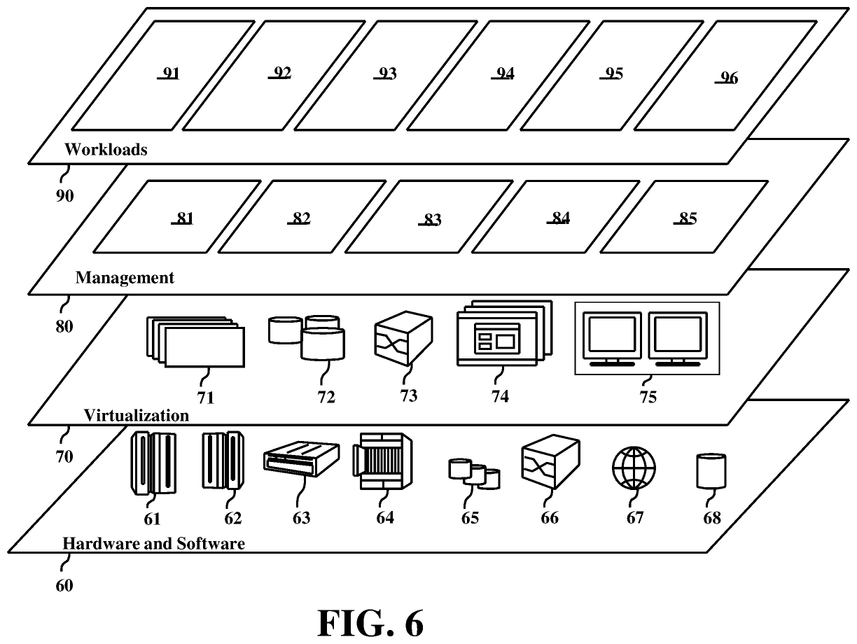

Referring now to FIG. 6, a set of functional abstraction layers provided by cloud computing environment 50 (depicted in FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and intelligent task message queue management 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

What is claimed is:

1. A computer-implemented method for intelligent task message queue management, the method comprising:
assigning, by a processor, a subclass to a task message based on a predetermined set of rules, wherein a plurality of subclasses exist within an intelligent task message queue management service;
assigning, by the processor, the task message to a subclass worklist queue based on the assigned subclass, wherein each of the plurality of subclasses has a corresponding subclass worklist queue;
generating, by the processor, a subclass score for the task message based, at least in part, on a weight associated with the subclass worklist queue; and
dispatching, by the processor, the task message to a consumer based, at least in part, on the generated subclass score for the task message.

2. The computer-implemented method of claim 1, further comprising:
receiving, by the processor, the task message from a producer.

3. The computer-implemented method of claim 2, further comprising:
refreshing, by the processor, the weight associated with the subclass worklist queue to a preconfigured value.

4. The computer-implemented method of claim 1, further comprising:
receiving, by the processor, an acknowledgement that the dispatched task message has been received by the consumer, wherein the acknowledgement includes the subclass score for the task message; and
updating, by the processor, the weight of the subclass worklist queue based, at least in part, on the received acknowledgement.

5. The computer-implemented method of claim 1, further comprising:
receiving, by the processor, a plurality of acknowledgements for each of a plurality of dispatched task messages that have been received by one or more consumers, wherein each acknowledgement in the plurality of acknowledgements includes a corresponding subclass score associated with the subclass working queue;
accumulating, by the processor, each subclass score associated with the subclass worklist queue; and
updating, by the processor, the weight of the subclass worklist queue based, at least in part, on the accumulated subclass scores.

6. The computer-implemented method of claim 1, wherein generating the score for the task message further comprises:
determining, by the processor, a priority of the producer of the task message; and
calculating, by the processor, the subclass score for the task message based, at least in part, on the priority of the producer of the task message and the weight of the subclass worklist queue.

7. The computer-implemented method of claim 1, wherein the intelligent task message queue management service is a multi-tenant service comprised of a plurality of producers, wherein each producer has a corresponding priority level.

8. The computer-implemented method of claim 7, wherein a priority level is based on a subscription plan of the producer.

9. The computer-implemented method of claim 1, wherein the intelligent task message queue management service is composed of a plurality of consumers, wherein the plurality of consumers can execute each task message.

10. The computer-implemented method of claim 1, wherein the task message is a task encapsulated as a message that can be sent to the consumer, wherein the consumer executes the task encapsulated as the message.

11. A computer system for intelligent task message queue management, the system comprising:
a memory; and
a processor in communication with the memory, the processor being configured to perform operations comprising:
assign a subclass to a task message based on a predetermined set of rules, wherein a plurality of subclasses exist within an intelligent task message queue management service;
assign the task message to a subclass worklist queue based on the assigned subclass, wherein each of the plurality of subclasses has a corresponding subclass worklist queue;
generate a subclass score for the task message based, at least in part, on a weight associated with the subclass worklist queue; and
dispatch the task message to a consumer based, at least in part, on the generated subclass score for the task message.

12. The computer system of claim 11, further comprising operations to:
receive the task message from a producer.

13. The computer system of claim 12, further comprising operations to:
refresh the weight associated with the subclass worklist queue to a preconfigured value.

14. The computer system of claim 11, further comprising operations to:
receive an acknowledgement that the dispatched task message has been received by the consumer, wherein the acknowledgement includes the subclass score for the task message; and
update the weight of the subclass worklist queue based, at least in part, on the received acknowledgement.

15. The computer system of claim 11, further comprising operations to:
receive a plurality of acknowledgements for each of a plurality of dispatched task messages that have been received by one or more consumers, wherein each acknowledgement in the plurality of acknowledgements includes a corresponding subclass score associated with the subclass working queue;
accumulate each subclass score associated with the subclass worklist queue; and
update the weight of the subclass worklist queue based, at least in part, on the accumulated subclass scores.

16. A computer program product for intelligent task message queue management having program instructions embodied therewith, the program instructions executable by a processor to cause the processors to perform a function, the function comprising:
assign a subclass to a task message based on a predetermined set of rules, wherein a plurality of subclasses exist within an intelligent task message queue management service;
assign the task message to a subclass worklist queue based on the assigned subclass, wherein each of the plurality of subclasses has a corresponding subclass worklist queue;
generate a subclass score for the task message based, at least in part, on a weight associated with the subclass worklist queue; and
dispatch the task message to a consumer based, at least in part, on the generated subclass score for the task message.

17. The computer program product of claim 16, further comprising instructions to:
receive the task message from a producer.

18. The computer program product of claim 17, further comprising instructions to:
refresh the weight associated with the subclass worklist queue to a preconfigured value.

19. The computer program product of claim 16, further comprising instructions to:
receive an acknowledgement that the dispatched task message has been received by the consumer, wherein the acknowledgement includes the subclass score for the task message; and
update the weight of the subclass worklist queue based, at least in part, on the received acknowledgement.

20. The computer program product of claim 16, further comprising instructions to:
receive a plurality of acknowledgements for each of a plurality of dispatched task messages that have been received by one or more consumers, wherein each acknowledgement in the plurality of acknowledgements includes a corresponding subclass score associated with the subclass working queue;
accumulate each subclass score associated with the subclass worklist queue; and
update the weight of the subclass worklist queue based, at least in part, on the accumulated subclass scores.
